(19) United States
(12) Patent Application Publication
(10) Pub. No.: US 2010/0315246 A1
(43) Pub. Date: Dec. 16, 2010

(54) ENGINE OIL-LEVEL DETECTION SYSTEM

(75) Inventor: Richard J. Gilpatrick, Whitewater, WI (US)

Correspondence Address: Foley & Lardner LLP, 777 East Wisconsin Avenue, Milwaukee, WI, 53202-5306, US

(73) Assignee: Briggs & Stratton Corporation

(21) Appl. No.: 12/483,134

(22) Filed: Jun. 11, 2009

(51) Int. Cl. G08B 21/00

(52) U.S. Cl. 340/623; 340/618

(57) ABSTRACT

An oil-level detection system for an engine-powered product includes a dipstick designed to be received within a crankcase. The system further includes a detector attached to the dipstick, where the detector is designed to sense, from within the crankcase, a level of oil within the crankcase. The system also includes a display in communication with the detector. The display identifies information to a user related to the level of oil within the crankcase, without the user opening the crankcase.

### BACKGROUND

The present invention relates generally to the field of lubrication systems for combustion engines. More specifically, the present invention relates to devices for detecting and indentifying to a user the level of oil in a combustion engine.

Checking the oil level is a typical task for engine maintenance. Without sufficient oil, an engine may overheat, excessively wear, or otherwise undergo undesirable stress, causing engine damage that is potentially severe.

A dipstick can be used to check the oil level in an engine. To use a dipstick, the engine should be set on a flat and level surface so that oil within the engine forms of pool at the bottom of the crankcase. Ideally, the engine should be allowed to sit until the oil settles and cools. Many engines include an oil fill cap with a dipstick attached to an inside surface of the fill cap. To inspect the oil level, the oil fill cap and dipstick are lifted away from a fill hole and the dipstick is wiped clean, such as with a rag or paper towel. Then the dipstick is reinserted into the fill hole and removed once again. Typically dipsticks have hash marks or pin holes indicative of a proper oil level. Visual inspection of oil clinging to the dipstick indicates the oil level in the engine. If the oil level is too low, then additional oil may added.

### SUMMARY

One embodiment of the invention relates to an oil-level detection system for an engine-powered product. The system includes a dipstick designed to be received within a crankcase. The system further includes a detector attached to the dipstick, where the detector is designed to sense, from within the crankcase, a level of oil within the crankcase. The system also include a display in communication with the detector. The display identifies information to a user related to the level of oil within the crankcase, without the user opening the crankcase.

Another embodiment of the invention relates to an engine with an oil-level detection system. The engine includes a crankcase designed to hold oil for lubrication within the crankcase. Also, the engine includes a detector, designed to detect a level of oil within the crankcase, and circuitry attached to the detector. The circuitry is designed to interpret readings from the detector. The engine further includes a display in communication with the circuitry. The display identifies to a user the level of oil in the crankcase, without the user removing oil from the crankcase.

Yet another embodiment of the invention relates to an oil-level detection system for an engine-powered product. The system includes an oil fill cap and a dipstick fastened to an underside of the oil fill cap. The dipstick has a hollow shaft. The system also includes a detector attached to a first end of the dipstick. The system further includes a display attached to the oil fill cap. The display and the detector are in electrical communication via a wire extending through the hollow shaft.

Alternative exemplary embodiments relate to other features and combinations of features as may be generally recited in the claims.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a perspective view of a pressure washer with an oil-level detection system according to an exemplary embodiment.

FIG. 2 is a sectional view of a crankcase having an oil-level detection system according to an exemplary embodiment.

FIG. 3 is perspective view of an oil-level detection system according to an exemplary embodiment.

FIG. 4 is a sectional view of a crank case having an oil-level detection system according to an exemplary embodiment.

FIG. 5 is a sectional view of a crank case having an oil-level detection system according to another exemplary embodiment.

### DETAILED DESCRIPTION OF EXEMPLARY EMBODIMENTS

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

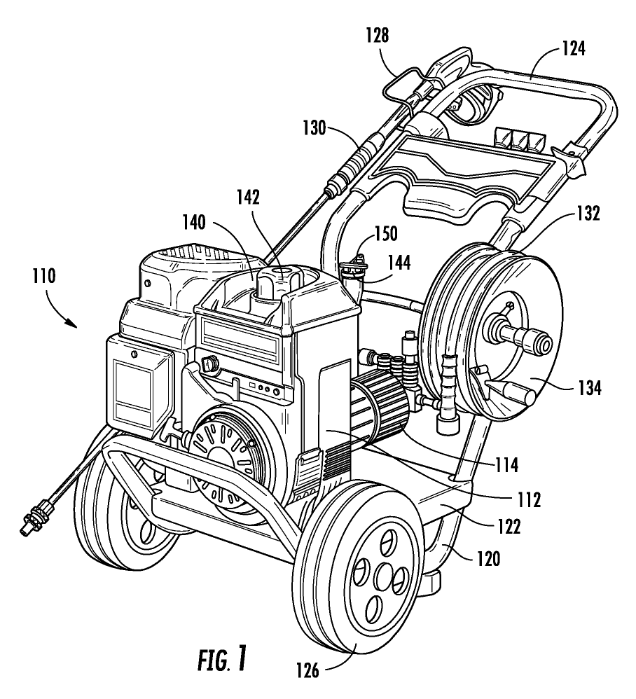

FIG. 1 shows power equipment employing an oil-level detection system according to an exemplary embodiment. The power equipment is in the form of a pressure washer 110 having a horizontal-shaft combustion engine 112 fastened to a water pump 114. The engine 112 includes a fuel tank 140 with a fuel cap 142, and a lubrication system with an oil fill cap 144. The lubrication system uses the oil-level detection system to provide a user with information pertaining a level of oil within the engine 112, such as whether the level of oil is within, above, or below a predetermined threshold range. The information is provided to the user via a display, such as a liquid crystal display 150 shown coupled to the fill cap 144. Using the oil-level detection system, the user need not directly access the oil within the engine 112 to receive the information.

Still referring to FIG. 1, the engine 112 is mounted on a frame 120 having a base plate 122, a handle 124, and wheels 126. The engine 112 and the pump 114 are fastened to the base plate 122. The frame 120 further includes a pressure washer gun 130 held in a holster 128 and a hose 132 on a hose reel 134. While the pressure washer 110 provides one exemplary environment for an oil-level detection system, other environments include a broad range of power equipment and other engine applications. For example, oil-level detection systems may be employed with the combustion engines of lawn mowers and power generators.

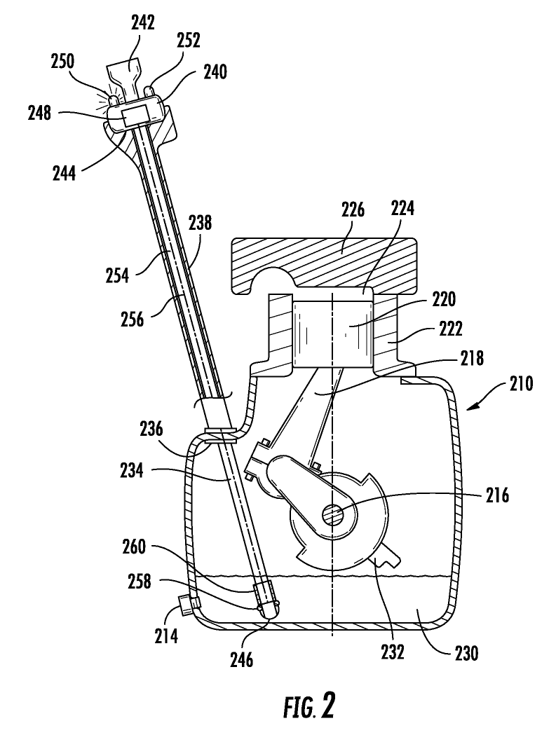

FIG. 2 shows a sectional view of an oil-level detection system according to an exemplary embodiment. An engine crankcase 210, such as for the engine 112, contains a horizontal crankshaft 216 (oriented directly into FIG. 2) coupled to a piston 220 via a connecting rod 218. The piston 220 translates back and forth within a cylinder 222 in response to combustion occurring within a combustion chamber 224 that is formed between the cylinder 222, the piston 220, and a cylinder head 226. Translational motion of the piston 220 is converted into rotational motion of the crankshaft 216. The rotational motion of the crankshaft 216 may be delivered to a powered tool, such as a pressure washer pump, lawn mower blade, electric generator rotor, or other powered tools.

The crankcase 210 holds a liquid lubricant, such as oil collected in a reservoir 230 within a base of the crankcase 210. A lubricant distributor, such as a slinger 232, moves the oil to components within the crankcase 210. Other embodiments include lubricant distributors in the form of dippers, sump pumps, or another devices. In FIG. 2, a dipstick 234 is shown extending into the crankcase 210 via a port 236 in the crankcase 210. Coupled to the port 236 is a conduit 238, through which the dipstick 234 extends. A fill cap 240 rests on the top of the conduit 238 to seal the conduit 238. The fill cap 240 can be opened by lifting or twisting a handle 242 on top of the fill cap 240. When the fill cap 240 is opened, a filler hole 244 on the top of the conduit 238 is accessible. Refill oil may be poured, typically with the aid of a funnel, through the filler hole 244 and into through the conduit 238. The oil then is directed through the port 236 into the reservoir 230 of oil within the crankcase 210. An oil drain plug 214 is positioned proximate to the base of the crankcase 210, where the oil drain plug 214 can be removed to drain oil from the crankcase 210.

As shown in FIG. 2, the oil-level detection system includes the dipstick 234. The dipstick 234 has a shaft 254, a detector 246, and a display. In some embodiments, the dipstick 234 further includes a wire 256 running through the shaft 254 to connect the detector 246 to circuitry 248. The circuitry 248 is configured to interpret a reading from the detector 246 and convert the reading into signals directed to the user via the display. In some exemplary embodiments, the dipstick 234 further includes a user interface, such as a button 252. The user may press the button 252 to actuate the detector 246, the circuitry 248, or the display.

In the embodiment of FIG. 2, the display signals are provided by a light-emitting diode 250, which indicates to the user when the oil level is below a certain threshold. In other embodiments, the display includes a liquid crystal display with back lighting to allow the user to read a visual signal provided. In still other embodiments, the display includes organic light-emitting diodes, a warning buzzer, a mechanical dial or gauge, a light bulb, or other display features and combinations of such features. In some embodiments, the display is powered by battery, by engine power, or other power sources. For example, in one embodiment the engine charges secondary batteries that power the light-emitting diode 250.

In some embodiments, the circuitry 248 includes a processor, a logic module, memory, and internal and external interfaces coupling the circuitry 248 to other components, such as interfaces that couple to the detector 246, the display, and the button 252. The components and interfaces may be coupled via data transmission or communication media, such as fiber optic or coaxial cable, wiring, radio or infrared signal transmitters and receivers, hydraulic or pneumatic channels, mechanical linkages, etc. The processor may receive inputs from the detector 246 or other sensors, the button 252, the memory, the logic module, and other sources. The button 252 may include a graphical user interface including a touch screen or other interfaces, such as buttons, knobs, dials, a keyboard, toggles, etc., allowing a user to interact with the circuitry 248, which may then communicate back to the user through the display, such as the liquid crystal display 150 and the light-emitting diode 250.

The processor receives instructions from the logic module or logic stored in the memory, and additional inputs from other items, such as a digital clock or a band-pass filter (for removing noise from signals from the detector 246), and produces instructions to operate the display, or other features of the oil lubrication system, such as a magnet or inspection light coupled to the dipstick 234. Inputs and logic may be evaluated, calculated, and manipulated by the processor, where the processor or one or more components coupled to processor, may be configured to provide a controller output signal or command the display or other components of the engine 112. As such, the output signal or command (e.g., activate the light-emitting diode 250) is based upon calculations performed in the processor. The processor can also be or include one or more processing components or processors. The processor can be a general purpose processor, an application-specific integrated circuit, or any other collection of circuitry components configured to conduct the calculations or to facilitate the activities described herein. The processor can be configured to execute computer code, script code, object code, or other executable instructions stored in the memory, other memory, or in the processor. In some embodiments, the memory may store coded instructions, such as the logic module, in various states, such as volatile, non-volatile, random-access memory, read-only memory, solid states, and the like. In certain embodiments, the logic module may be stored in a separate memory, such as a memory of one or more remote computers coupled to the circuitry 248 of the lubrication system via radio frequency communication to an external computer network, local area network, or the internet. The logic module is configured to run in the processor of the circuitry 248 in one or more steps based upon pre-assigned instructions, data stored in the memory, input from the button 252, input from the detector 246 or other sensors and sources.

The circuitry 248 may control the light-emitting diode 250. For example, in one embodiment, the detector 246 indentifies to the processor a magnitude of oil in the reservoir 230. The processor also retrieves a threshold oil level from the memory, where the threshold corresponds to a minimum preferred volume of oil in the reservoir 230. The processor then compares the sensed oil magnitude to the threshold. If the sensed magnitude is less than the threshold, the circuitry 248 may activate an indicator on the display, such as the light-emitting diode 250. In at least one embodiment, an informational message may be presented on the light-emitting diode 250 reporting that the sensed amount of oil is below the threshold (e.g., a red light-emitting diode may be lighted). However, if the sensed oil magnitude exceeds the threshold, then the circuitry 248 may provide a different signal, such as lighting a green light-emitting diode.

In some embodiments, the circuitry 248 may provide a corresponding informational warning message on the display to inform the user that the sensed oil magnitude is below a first threshold (e.g., near the minimum required volume for proper engine operation). If the sensed oil magnitude drops below a second threshold (e.g., the minimum required volume), then the circuitry 248 may prevent the engine 112 from operating (e.g., by blocking ignition) and simultaneously displaying a fault code or providing an alarm (e.g., beeping sound or blinking red light-emitting diode).

According to the embodiment shown in FIG. 2, the dipstick 234 may be pulled out of the conduit 238 by lifting the handle 242. Once removed from the conduit 238, the user can visually inspect oil clinging to the dipstick 234. The dipstick 234 further includes an inspection light 258 attached to the shaft 254. In some embodiments, the inspection light 258 is a light-emitting diode embedded within a clear plastic segment of the dipstick. In other embodiments, the inspection light 258 includes multiple light-emitting diodes, organic light-emitting diodes, a light bulb, fiber optic cables coupled to a light source in the oil fill cap 240, or other light sources. Activation of the inspection light 258 may be controlled by the circuitry 248. When activated, the inspection light 258 shines through oil on the dipstick 234 to help the user characterize the state of the oil. For example, as highlighted by the inspection light 258, the color of the oil may appear dark and cloudy, corresponding to dirt and other particles trapped in the oil.

The dipstick 234 of FIG. 2 further includes an oil cleaning device. The oil cleaning device is shown as a magnet 260 coupled to a surface on an end of the dipstick 234. The magnet 260 interfaces directly with the oil in the crankcase or indirectly with the oil, such as through an intermediate surface. The magnet 260 attracts particles, such as iron particles, within the oil and pulls them from the oil to clean the oil. In some embodiments, the magnet 260 is an electro-magnet powered by a primary battery, capacitor, or secondary battery that may be charged or recharged by power drawn from the engine 112. In other embodiments, the magnet is a permanent magnet of a ferromagnetic material. In some embodiments, the surface area of the magnetic section of the dipstick 234 is increased by adding structural flanges, waves, baffles, netting, extensions, and other structures to allow for greater surface area of the magnetic section to increase attraction of particles in the oil. When the dipstick 234 is removed from the crankcase 210, the surface of the dipstick 234 may be wiped clean and reinserted to continue cleaning the oil. Operation of the magnet 260 may be controlled by the circuitry 248.

In other embodiments the detector 246 and the light-emitting diode 250 are not fastened to the dipstick 234. For example, in at least one embodiment, the dipstick 234 does not include a detector, but does include the inspection light 258. In another embodiment, the dipstick 234 does not include an inspection light, but does include the magnet 260. In yet another embodiment, the dipstick 234 includes the detector 246 coupled to the light-emitting diode 250 by mechanical means, such as mechanic linkages instead of the wire 256. The light-emitting diode 250 may use potential energy absorbed by a spring coupled to the mechanical linkages to adjust an indicator of the oil level, such as a dial, pointer, arrow, bar, or other indicator. In still other embodiments, the display is mounted on an engine cover.

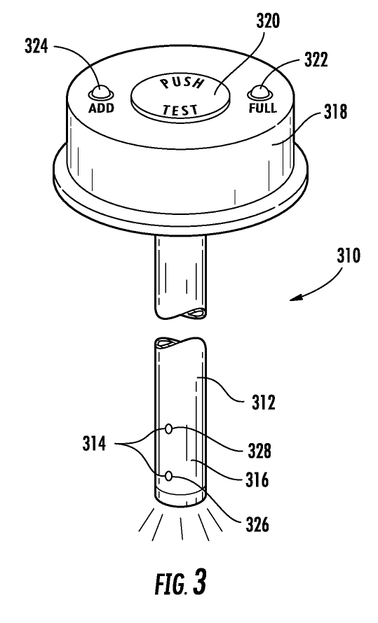

FIG. 3 shows a liquid-level detection system according to an exemplary embodiment. The detection system is shown in the form of a dipstick 310 having a shaft 312 with a detector 314 on a dipping end 316 of the shaft 312. The dipstick 310 further includes a cap 318 having a user interface in the form of a button 320 and indicators in the form of light emitting diodes 322, 324. The dipstick 310 may be inserted into a liquid container, with the cap 318 mounted on an outside wall of the container. The user presses the button 320 to initiate a test of the liquid level. The detector 314 interfaces with liquid in the container to determine information about a quantity or volume of the liquid in the container. Results of the test are displayed by the light emitting diodes 322, 324.

In some embodiments, the shaft 312 may be sized to measure a desired level of liquid within the container. For example, the shaft 312 may be a telescoping shaft to allow for different shaft lengths. While the dipstick 310 shown in FIG. 3 includes the shaft 312 that is hollow, other embodiments include shafts that are solid or solid with hollow portions.

The detector 314 shown in FIG. 3 senses a capacitance between two locations on the dipstick 310. In an exemplary embodiment, the detector 314 includes two electrically conductive nodes 326, 328. The nodes 326, 328 are separated and function together as a capacitor. In some embodiments, the nodes 326, 328 are pins, plates, wires, grids, or other conductive elements. A power source, such as a battery within the cap 318, provides a charge to the capacitor. Electric potential between the nodes 326, 328 varies depending upon the liquid level in the container. A controller using circuitry calculates information related to the liquid level sensed by the detector 314 via the measured potential. The controller then activates the light emitting diodes 322, 324 in a manner to identify to the user information related to the liquid level. For example, a measured electric potential above a first threshold but below a second threshold may indicate a liquid level in the container that is within a predetermined range. The controller would then activate the light emitting diode 322 corresponding to the container being “full.” But a measured electric potential below the first threshold may indicate a liquid level below the predetermined range. The controller would then activate the light emitting diode 324 corresponding to “add” liquid.

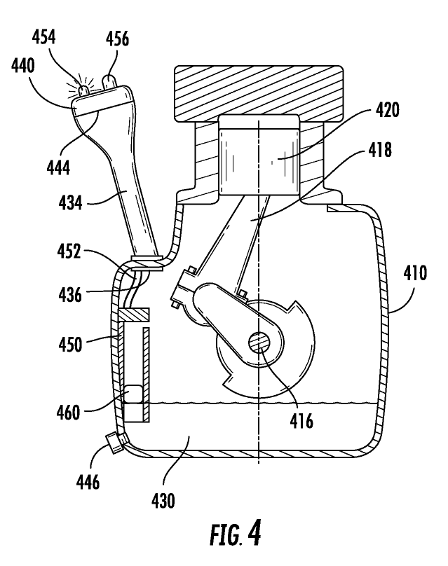

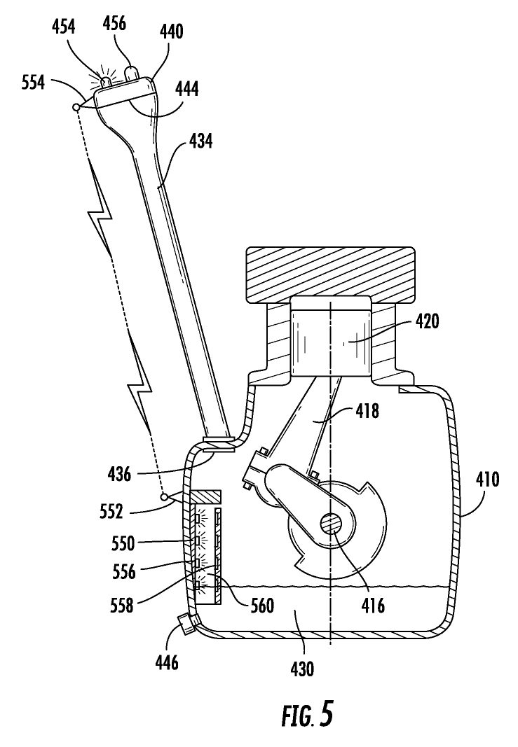

FIGS. 4-5 show a sectional view of container with an oil-level detection system according to an exemplary embodiment. The container is in the form of an engine crankcase 410, containing a crankshaft 416, a piston 420, and a connecting rod 418. The crankcase 410 holds oil collected in a reservoir 430. An oil refill conduit 434 extends into the crankcase 210 via a port 436. A fill cap 440 rests on the top of the conduit 434. When the fill cap 440 is open, a filler hole 444 on the top of the conduit 434 is accessible. An oil drain plug 446 is positioned at the base of the crankcase 410.

The oil-level detection system of FIG. 4 includes a detector in the form of a mounted sensor 450. A wire 452 extends from the sensor 450 to a controller coupled to a display in the form of a light-emitting diode 454 indicator on top of the fill cap 440. The controller interprets readings from the mounted sensor 450 and converts the readings into signals directed to the user via the light-emitting diode 454. A user interface in the form of an adjustable knob 456 is positioned on the fill cap 440. Turning the knob 456 activates the oil-level detection system.

The mounted sensor 450 of FIG. 4 includes a float 460. In some embodiments, the float 460 holds a magnet that slides within a glass tube of a reed switch. An electric potential generated by the reed switch provides an electric signal that varies in response to the position of the float 460 within the sensor 450. The electric signal is transmitted to the controller by the wire 452. In another embodiment, the float 460 is biased by a spring, a flexible rod, or another biasing member, and potential energy stored in the biasing member is measured by a pressure sensor, such as piezo-electric crystals. The pressure sensor generates an electric signal that varies in response to the position of the float 460, and the signal is transmitted to the controller by the wire 452. In yet another embodiment, potential energy of the biasing member is transmitted by mechanical linkage (e.g., pulley, rod, gearing, etc.) to the display, such as an indicator dial, guage, or needle. In still another embodiment, the float 460 is coupled to a potentiometer or transducer. The potentiometer translates the position of the float 460 into an electric signal transmitted directly or indirectly to the light-emitting diode 454.

As shown in FIG. 5, the oil-level detection system includes a detector in the form of a mounted sensor 550. The mounted sensor 550 is coupled to circuitry controlling the light-emitting diode 454. Radio frequency transceivers 552, 554 are used to facilitate communication between the mounted sensor 550 and the circuitry. In other embodiments, the mounted sensor 550 is coupled to a transmitter and the circuitry is coupled to a receiver. While in the embodiment of FIG. 5 the circuitry is within the fill cap 440, in other embodiments the circuitry may be in other locations reachable by electromagnetic signals sent from the mounted sensor 550. The circuitry interprets a reading from the mounted sensor 550 and converts the reading into signals directed to the user via a display, such as the light-emitting diode 454.

The mounted sensor 550 includes a light 556 (e.g., a visual-range light emitting diode, a laser diode, an infrared light emitting diode, a light bulb, etc.) and a sensor 558 (e.g., a photodetector, a photovoltaic cell, a photoresistor, etc.). The light 556 and the sensor 558 are separated by a canal 560 through which the oil can flow. Within the canal 560, oil absorbs light produced by the light 556. The sensor 558 produces an electric signal that is a function of the magnitude of the light sensed. As the level of oil in the crankcase 410 changes, the amount of light sensed by the sensor 558 varies, and a corresponding electric signal produced by the sensor 558 varies. The signal is transmitted by the transceivers 552, 554 directly or indirectly (via the circuitry) to the light-emitting diode 454.

In still other embodiments, an oil-level detector includes pressure sensors or other load-sensitive sensors (e.g., load cells). Oil level is proportional to pressure sensed at a location within the oil, such as oil at the base of the oil reservoir 230. The pressure sensors may be coupled to the an end of a dipstick, to a mounted sensor, or to the outside of a crankcase. In at least one embodiment, a pressure sensor includes a diaphragm coupled to a magnet extending within a glass tube of a reed switch. Deflection of the diaphragm due to changes in pressure cause the reed switch to produce an electric signal that is a function of the oil level. The signal is interpreted by circuitry and relayed to the user via the display.

The construction and arrangements of the oil-level detection systems, as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. In some embodiments, the display is positioned apart from the fill cap 240, such as on a panel or console on the frame 120 of the pressure washer 110. The detectors associated with the mounted sensors 450, 550 and other embodiments can be coupled to dipsticks, such as inserted within or attached to an end of the dipstick 234. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. An oil-level detection system for an engine-powered product, comprising:
a dipstick configured to be received in a crankcase;
a detector coupled to the dipstick, the detector configured to sense from within the crankcase a level of oil within the crankcase; and
a display in communication with the detector, wherein the display identifies information to a user related to the level of oil within the crankcase without removing the dipstick from the crankcase.

2. The system of claim 1, wherein the system further comprises a user interface, configured to activate the display and the detector.

3. The system of claim 2, wherein the display is attached to an end of the dipstick.

4. The system of claim 3, wherein the detector comprises an electrically-powered sensor.

5. The system of claim 4, wherein the dipstick comprises a hollow shaft.

6. The system of claim 5, wherein the detector is in electrical communication with the display via a wire extending through the hollow shaft.

7. The system of claim 6, wherein the sensor measures capacitance.

8. The system of claim 6, wherein the detector comprises a float.

9. The system of claim 6, wherein the dipstick comprises an inspection light to aid in the visual inspection of the color of the oil.

10. The system of claim 6, wherein the dipstick comprises a magnet that separates iron particles from the oil.

11. An engine with an oil-level detection system, comprising:
a crankcase configured to hold oil;
a detector configured to detect a level of oil within the crankcase;
circuitry coupled to the detector, the circuitry configured to interpret readings from the detector;
a dipstick having a shaft, the dipstick configured to be received in the crankcase; and
a display in communication with the circuitry, the display coupled to the dipstick, wherein the display identifies to a user the level of oil in the crankcase without removing the dipstick from the crankcase.

12. The engine of claim 11, wherein the detector is in electrical communication with the display via a wire extending through the shaft.

13. The engine of claim 12, wherein the detector is coupled to a first end of the dipstick and the display is coupled to a second end of the dipstick.

14. The engine of claim 13, wherein the detector comprises a sensor to measure capacitance.

15. The engine of claim 13, wherein the detector comprises a float.

16. The engine of claim 13, wherein the detector comprises a light and a sensor.

17. The engine of claim 13, wherein the detector comprises a pressure sensor.

18. An oil-level detection system for an engine-powered product, comprising:
an oil fill cap;
a dipstick fastened to an underside of the oil fill cap, the dipstick having a hollow shaft;
a detector coupled to a first end of the dipstick; and
a display coupled to the oil fill cap, wherein the display and the detector are in electrical communication via a wire extending through the hollow shaft.

19. The system of claim 18, wherein the detector comprises at least one of an electrical sensor to measure capacitance, a float, a light and a sensor, or a pressure sensor.

20. The system of claim 19, wherein the oil fill cap further includes a button to activate the system.
